(19) United States
(12) Patent Application Publication
(10) Pub. No.: US 2026/0039748 A1
(43) Pub. Date: Feb. 5, 2026

(54) TECHNOLOGIES FOR USING PATTERN MINING TO REDUCE NOISE AND EXTRACT INSIGHTS FOR EVENT SEQUENCE VISUALIZATION

(71) Applicant: Genesys Cloud Services, Inc., Menlo Park, CA (US)

(72) Inventors: Ankit Pat, Menlo Park, CA (US); Antonello Crea, Galway (IE)

(21) Appl. No.: 18/790,546

(22) Filed: Jul. 31, 2024

(51) Int. Cl. H04M 3/493; G06F 18/23213

(52) U.S. Cl. CPC H04M 3/493; G06F 18/23213

(57) ABSTRACT

A method for reducing noise for event sequence visualization according to an embodiment includes identifying patterns of events from an event sequence dataset, wherein the event sequence dataset includes data for a plurality of event sequences, and wherein each event sequence of the plurality of events sequences includes at least one event, encoding each event sequence of the plurality of event sequences into a respective vector embedding based on the identified patterns of events to generate a plurality of vectors, executing a clustering algorithm on the plurality of vectors to generate a plurality of clusters, assigning each event sequence of the plurality of event sequences to a respective cluster of the plurality of clusters, generating a reduced dataset based on the assignment of the plurality of event sequences to the plurality of clusters, and building a data structure for event sequence visualization based on the reduced dataset.

### BACKGROUND

Call centers and other contact centers are used by many organizations to provide technical and other support to their end users. The end user may interact with human and/or virtual agents of the contact center by establishing electronic communications via one or more communication technologies including, for example, telephone, email, web chat, Short Message Service (SMS), dedicated software application(s), and/or other technologies. In particular, the end user may interact with an interactive voice response (IVR) system of the contact center that uses a series of predefined prompts and user responses to determine how to address the user's concerns, for example, by leveraging one or more bot flows defined by a contact center administrator.

### SUMMARY

One embodiment is directed to a unique system, components, and methods for using patent mining to reduce noise and/or extract insights for event sequence visualization. Other embodiments are directed to apparatuses, systems, devices, hardware, methods, and combinations thereof for using patent mining to reduce noise and/or extract insights for event sequence visualization.

According to an embodiment, a method reducing noise for event sequence visualization may include identifying, by a computing system, patterns of events from an event sequence dataset, wherein the event sequence dataset includes data for a plurality of event sequences, and wherein each event sequence of the plurality of events sequences includes at least one event, encoding, by the computing system, each event sequence of the plurality of event sequences into a respective vector embedding based on the identified patterns of events to generate a plurality of vectors, executing, by the computing system, a clustering algorithm on the plurality of vectors to generate a plurality of clusters, assigning, by the computing system, each event sequence of the plurality of event sequences to a respective cluster of the plurality of clusters, generating, by the computing system, a reduced dataset based on the assignment of the plurality of event sequences to the plurality of clusters, and building, by the computing system, a data structure for event sequence visualization based on the reduced dataset.

In some embodiments, building the data structure for event sequence visualization based on the reduced dataset may include building a Trie data structure for event sequence visualization based on the reduced dataset.

In some embodiments, identifying the patterns of events from the event sequence dataset may include identifying patterns of events that occur at least a threshold number of times in the event sequence dataset.

In some embodiments, identifying the patterns of events from the event sequence dataset comprises identifying patterns of events that occur at least twice in the event sequence dataset.

In some embodiments, encoding each event sequence of the plurality of event sequences into the respective vector embedding may include encoding each event sequence of the plurality of event sequences into a respective vector embedding using one-hot encoding.

In some embodiments, executing the clustering algorithm on the plurality of vectors to generate the plurality of clusters may include executing a k-means clustering algorithm on the plurality of vectors to generate the plurality of clusters.

In some embodiments, assigning each event sequence of the plurality of event sequences to the respective cluster of the plurality of clusters may include assigning each event sequence of the plurality of event sequences to one and only one respective cluster of the plurality of clusters.

In some embodiments, assigning each event sequence of the plurality of event sequences to the respective cluster of the plurality of clusters may include assigning each event sequence of the plurality of event sequences to a medoid or centroid determined by the clustering algorithm.

In some embodiments, each event sequence of the plurality of event sequences may be or include a contact center bot flow of an organization.

In some embodiments, the event sequence dataset may include data associated with events of an interactive voice response (IVR) system of a contact center system.

In some embodiments, the method may further include displaying, by the computing system, a graphical representation of the data structure for event sequence visualization in response to building the data structure.

According to another embodiment, a system of reducing noise for event sequence visualization may include at least one processor and at least one memory comprising a plurality of instructions stored thereon that, in response to execution by the at least one processor, causes the system to identify patterns of events from an event sequence dataset, wherein the event sequence dataset includes data for a plurality of event sequences, and wherein each event sequence of the plurality of events sequences includes at least one event, encode each event sequence of the plurality of event sequences into a respective vector embedding based on the identified patterns of events to generate a plurality of vectors, execute a clustering algorithm on the plurality of vectors to generate a plurality of clusters, assign each event sequence of the plurality of event sequences to a respective cluster of the plurality of clusters, generate a reduced dataset based on the assignment of the plurality of event sequences to the plurality of clusters, and build a data structure for event sequence visualization based on the reduced dataset.

In some embodiments, to build the data structure for event sequence visualization based on the reduced dataset may include to build a Trie data structure for event sequence visualization based on the reduced dataset.

In some embodiments, to identify the patterns of events from the event sequence dataset may include to identify patterns of events that occur at least twice in the event sequence dataset.

In some embodiments, to encode each event sequence of the plurality of event sequences into the respective vector embedding may include to encode each event sequence of the plurality of event sequences into a respective vector embedding using one-hot encoding.

In some embodiments, to execute the clustering algorithm on the plurality of vectors to generate the plurality of clusters may include to execute a k-means clustering algorithm on the plurality of vectors to generate the plurality of clusters.

In some embodiments, to assign each event sequence of the plurality of event sequences to the respective cluster of the plurality of clusters may include to assign each event sequence of the plurality of event sequences to one and only one respective cluster of the plurality of clusters.

In some embodiments, to assign each event sequence of the plurality of event sequences to the respective cluster of the plurality of clusters may include to assign each event sequence of the plurality of event sequences to a medoid or centroid determined by the clustering algorithm.

In some embodiments, each event sequence of the plurality of event sequences may be or include a contact center bot flow of an organization.

In some embodiments, the event sequence dataset may include data associated with events of an interactive voice response (IVR) system of a contact center system.

This summary is not intended to identify key or essential features of the claimed subject matter, nor is it intended to be used as an aid in limiting the scope of the claimed subject matter. Further embodiments, forms, features, and aspects of the present application shall become apparent from the descriptions and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 depicts a simplified block diagram of at least one embodiment of a contact center system;

FIG. 2 is a simplified block diagram of at least one embodiment of a computing device;

FIGS. 3-4 are a simplified flow diagram of at least one embodiment of a method of using pattern mining to reduce noise for event sequence visualization;

FIG. 5 is a simplified flow diagram of at least one other embodiment of a method of using pattern mining to reduce noise for event sequence visualization;

FIG. 6 illustrates at least a portion of an example Trie data structure; and

FIG. 7 illustrates various data calculated during execution of the method of FIGS. 3-4.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should be further appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Further, particular features, structures, or characteristics may be combined in any suitable combinations and/or sub-combinations in various embodiments.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

It should be appreciated that event sequences such as web-based, chatbot-based (e.g., bot flows), and/or IVR-related journeys experienced by users exhibit substantial variability in the form of events that appear in then and the order of those events. Such variations lead to a significant amount of noise, which leads to difficulties with interpretability and explainability of outcomes as well as the steps involved in achieving those outcomes. This problem is further exacerbated when visualization is involved in any form. For example, a “spaghetti problem” is typically encountered when attempting to graphically display possible or actual event sequences encountered by a user in a lengthy or complex journey, in that the graphical representations of the respective event sequences interweave in a complex and indecipherable spaghetti-like mess. Additionally, the underlying data structure (e.g., a Trie data structure) typically explodes in size and complexity—leading to additional computational cost—which translates to poorer performance and higher operational costs. Accordingly, the technologies described herein reduce such noise and extract the most common patterns in the user journeys, for example, by leveraging pattern mining. It should be appreciated that a “Trie data structure” may be simplified referred to herein as a “Trie” for simplicity and brevity of the description. Further, it should be appreciated that alternative data structures may be used in other embodiments.

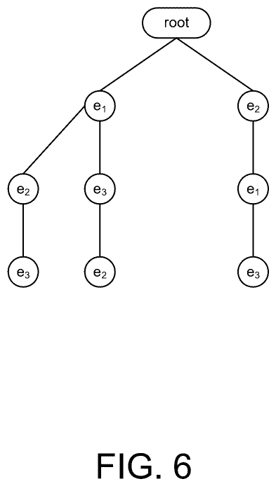

At least a portion of an example Trie data structure is illustrated in FIG. 6. The illustrative Trie is a simple example that includes only three different possible events (event e₁, event e₂, and event e₃). As shown, the illustrative Trie includes the event sequences (e₁, e₂, e₃), (e₁, e₃, e₂), and (e₂, e₁, e₃). It should be appreciated that the illustrative Trie may also involve various event subsequences of those illustrated event sequences (e.g., (e₁, e₂), (e₁, e₃), etc.). It should be further appreciated that, in other embodiments, even as few as three events may arranged to form an even greater number of possible event sequences than those illustrated in FIG. 6. Accordingly, the number of possible event sequences may increase exponentially as the number of possible events increases.

It should be appreciated that an “event” may be an action occurring at a specific point of time, such as, for example, a user logging into a system, a customer's or an agent's interaction with a chatbot, a user accessing an app or website of an organization, an email being sent or received, an agent's interaction with a user or another agent, a user's purchase of a product or service, a phase of an interactive voice response (IVR) interaction, a web-based event, or steps taken according to a predefined or reference workflow or script. It should be further appreciated that an “event” may be any action that occurs at a specific point of time and is capable of being monitored or logged by one or more of the various systems, devices, and components disclosed herein. For example, although events may be used to represent recorded customer or agent actions, they may also be used to represent changes to static data like updating or creating an address record or assigning demographic or segmentation data. In some embodiments, events may not be associated with a user.

In some embodiments, each event may include or otherwise be associated with one or more event attributes. Event attributes may include data or metadata describing characteristics of an event such as, for example, timestamps, event category data, geographic data, event sequence identifiers, enums, or any other type of structured or unstructured data. It should be appreciated that event attributes may include numeric and alphanumeric values. An event sequence, “flow,” “bot flow,” or “journey” may be a chronological set of events or actions associated with a single type of actor such as a customer or an agent. Each user may proceed in their own respective event sequence, journey, or flow, each of which may include any number of events.

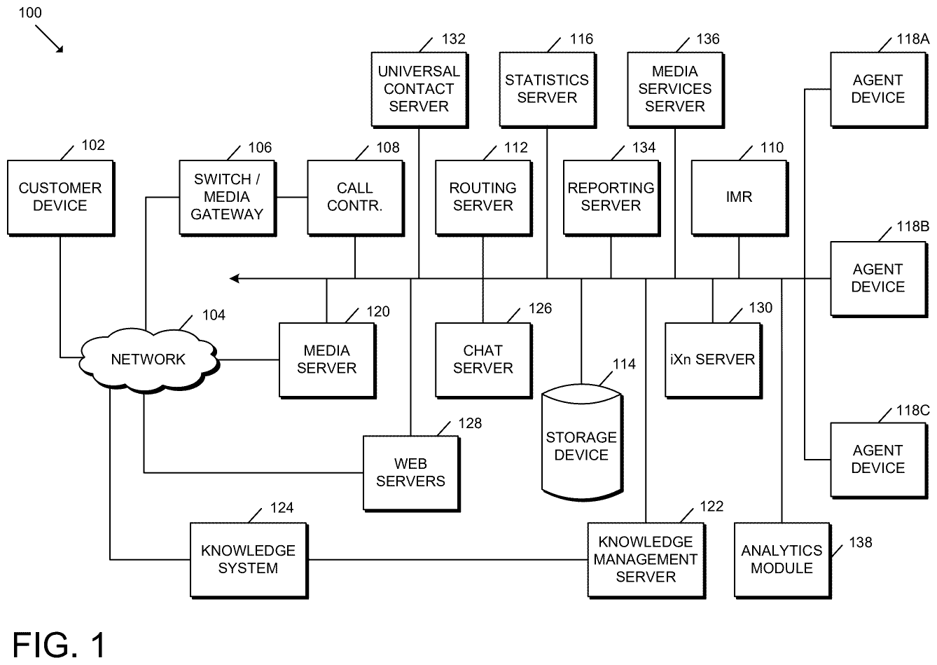

Referring now to FIG. 1, a simplified block diagram of at least one embodiment of a communications infrastructure and/or contact center system, which may be used in conjunction with one or more of the embodiments described herein, is shown. The contact center system 100 may be embodied as any system capable of providing contact center services (e.g., call center services, chat center services, SMS center services, etc.) to an end user and otherwise performing the functions described herein. The illustrative contact center system 100 includes a customer device 102, a network 104, a switch/media gateway 106, a call controller 108, an interactive media response (IMR) server 110, a routing server 112, a storage device 114, a statistics server 116, agent devices 118A, 118B, 118C, a media server 120, a knowledge management server 122, a knowledge system 124, chat server 126, web servers 128, an interaction (iXn) server 130, a universal contact server 132, a reporting server 134, a media services server 136, and an analytics module 138. Although only one customer device 102, one network 104, one switch/media gateway 106, one call controller 108, one IMR server 110, one routing server 112, one storage device 114, one statistics server 116, one media server 120, one knowledge management server 122, one knowledge system 124, one chat server 126, one iXn server 130, one universal contact server 132, one reporting server 134, one media services server 136, and one analytics module 138 are shown in the illustrative embodiment of FIG. 1, the contact center system 100 may include multiple customer devices 102, networks 104, switch/media gateways 106, call controllers 108, IMR servers 110, routing servers 112, storage devices 114, statistics servers 116, media servers 120, knowledge management servers 122, knowledge systems 124, chat servers 126, iXn servers 130, universal contact servers 132, reporting servers 134, media services servers 136, and/or analytics modules 138 in other embodiments. Further, in some embodiments, one or more of the components described herein may be excluded from the system 100, one or more of the components described as being independent may form a portion of another component, and/or one or more of the component described as forming a portion of another component may be independent.

It should be understood that the term “contact center system” is used herein to refer to the system depicted in FIG. 1 and/or the components thereof, while the term “contact center” is used more generally to refer to contact center systems, customer service providers operating those systems, and/or the organizations or enterprises associated therewith. Thus, unless otherwise specifically limited, the term “contact center” refers generally to a contact center system (such as the contact center system 100), the associated customer service provider (such as a particular customer service provider/agent providing customer services through the contact center system 100), as well as the organization or enterprise on behalf of which those customer services are being provided.

By way of background, customer service providers may offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals,” “customers,” or “contact center clients”). For example, the agents at a contact center may assist customers in making purchasing decisions, receiving orders, or solving problems with products or services already received. Within a contact center, such interactions between contact center agents and outside entities or customers may be conducted over a variety of communication channels, such as, for example, via voice (e.g., telephone calls or voice over IP or VoIP calls), video (e.g., video conferencing), text (e.g., emails and text chat), screen sharing, co-browsing, and/or other communication channels.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize some level of automated processes in place of live agents, such as, for example, interactive voice response (IVR) systems, interactive media response (IMR) systems, internet robots or “bots,” automated chat modules or “chatbots”, and/or other automated processed. In many cases, this has proven to be a successful strategy, as automated processes can be highly efficient in handling certain types of interactions and effective at decreasing the need for live agents. Such automation allows contact centers to target the use of human agents for the more difficult customer interactions, while the automated processes handle the more repetitive or routine tasks. Further, automated processes can be structured in a way that optimizes efficiency and promotes repeatability. Whereas a human or live agent may forget to ask certain questions or follow-up on particular details, such mistakes are typically avoided through the use of automated processes. While customer service providers are increasingly relying on automated processes to interact with customers, the use of such technologies by customers remains far less developed. Thus, while IVR systems, IMR systems, and/or bots are used to automate portions of the interaction on the contact center-side of an interaction, the actions on the customer-side remain for the customer to perform manually.

It should be appreciated that the contact center system 100 may be used by a customer service provider to provide various types of services to customers. For example, the contact center system 100 may be used to engage and manage interactions in which automated processes (or bots) or human agents communicate with customers. As should be understood, the contact center system 100 may be an in-house facility to a business or enterprise for performing the functions of sales and customer service relative to products and services available through the enterprise. In another embodiment, the contact center system 100 may be operated by a third-party service provider that contracts to provide services for another organization. Further, the contact center system 100 may be deployed on equipment dedicated to the enterprise or third-party service provider, and/or deployed in a remote computing environment such as, for example, a private or public cloud environment with infrastructure for supporting multiple contact centers for multiple enterprises. The contact center system 100 may include software applications or programs, which may be executed on premises or remotely or some combination thereof. It should further be appreciated that the various components of the contact center system 100 may be distributed across various geographic locations and not necessarily contained in a single location or computing environment.

It should further be understood that, unless otherwise specifically limited, any of the computing elements of the present invention may be implemented in cloud-based or cloud computing environments. As used herein and further described below in reference to the computing device 200, “cloud computing”—or, simply, the “cloud”—is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture,” a cloud execution model generally includes a service provider dynamically managing an allocation and provisioning of remote servers for achieving a desired functionality.

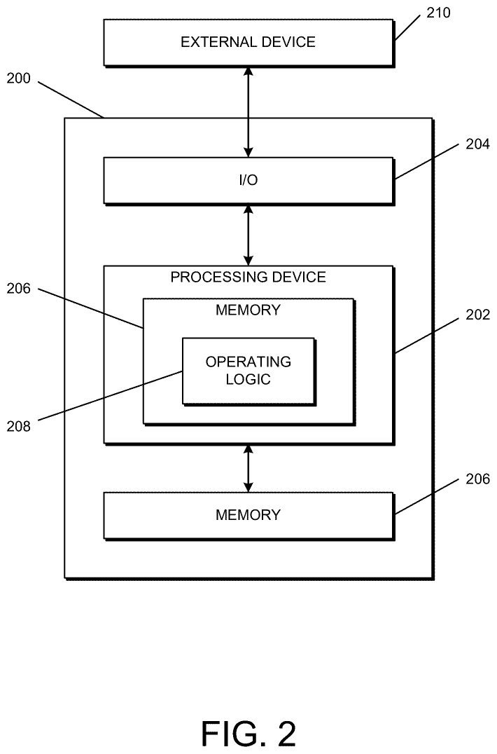

It should be understood that any of the computer-implemented components, modules, or servers described in relation to FIG. 1 may be implemented via one or more types of computing devices, such as, for example, the computing device 200 of FIG. 2. As will be seen, the contact center system 100 generally manages resources (e.g., personnel, computers, telecommunication equipment, etc.) to enable delivery of services via telephone, email, chat, or other communication mechanisms. Such services may vary depending on the type of contact center and, for example, may include customer service, help desk functionality, emergency response, telemarketing, order taking, and/or other characteristics.

Customers desiring to receive services from the contact center system 100 may initiate inbound communications (e.g., telephone calls, emails, chats, etc.) to the contact center system 100 via a customer device 102. While FIG. 1 shows one such customer device—i.e., customer device 102—it should be understood that any number of customer devices 102 may be present. The customer devices 102, for example, may be a communication device, such as a telephone, smart phone, computer, tablet, or laptop. In accordance with functionality described herein, customers may generally use the customer devices 102 to initiate, manage, and conduct communications with the contact center system 100, such as telephone calls, emails, chats, text messages, web-browsing sessions, and other multi-media transactions.

Inbound and outbound communications from and to the customer devices 102 may traverse the network 104, with the nature of the network typically depending on the type of customer device being used and the form of communication. As an example, the network 104 may include a communication network of telephone, cellular, and/or data services. The network 104 may be a private or public switched telephone network (PSTN), local area network (LAN), private wide area network (WAN), and/or public WAN such as the Internet. Further, the network 104 may include a wireless carrier network including a code division multiple access (CDMA) network, global system for mobile communications (GSM) network, or any wireless network/technology conventional in the art, including but not limited to 3G, 4G, LTE, 5G, etc.

The switch/media gateway 106 may be coupled to the network 104 for receiving and transmitting telephone calls between customers and the contact center system 100. The switch/media gateway 106 may include a telephone or communication switch configured to function as a central switch for agent level routing within the center. The switch may be a hardware switching system or implemented via software. For example, the switch 106 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 118. Thus, in general, the switch/media gateway 106 establishes a voice connection between the customer and the agent by establishing a connection between the customer device 102 and agent device 118.

As further shown, the switch/media gateway 106 may be coupled to the call controller 108 which, for example, serves as an adapter or interface between the switch and the other routing, monitoring, and communication-handling components of the contact center system 100. The call controller 108 may be configured to process PSTN calls, VOIP calls, and/or other types of calls. For example, the call controller 108 may include computer-telephone integration (CTI) software for interfacing with the switch/media gateway and other components. The call controller 108 may include a session initiation protocol (SIP) server for processing SIP calls. The call controller 108 may also extract data about an incoming interaction, such as the customer's telephone number, IP address, or email address, and then communicate these with other contact center components in processing the interaction.

The interactive media response (IMR) server 110 may be configured to enable self-help or virtual assistant functionality. Specifically, the IMR server 110 may be similar to an interactive voice response (IVR) server, except that the IMR server 110 is not restricted to voice and may also cover a variety of media channels. In an example illustrating voice, the IMR server 110 may be configured with an IMR script for querying customers on their needs. For example, a contact center for a bank may instruct customers via the IMR script to “press 1” if they wish to retrieve their account balance. Through continued interaction with the IMR server 110, customers may receive service without needing to speak with an agent. The IMR server 110 may also be configured to ascertain why a customer is contacting the contact center so that the communication may be routed to the appropriate resource. The IMR configuration may be performed through the use of a self-service and/or assisted service tool which comprises a web-based tool for developing IVR applications and routing applications running in the contact center environment.

The routing server 112 may function to route incoming interactions. For example, once it is determined that an inbound communication should be handled by a human agent, functionality within the routing server 112 may select the most appropriate agent and route the communication thereto. This agent selection may be based on which available agent is best suited for handling the communication. More specifically, the selection of appropriate agent may be based on a routing strategy or algorithm that is implemented by the routing server 112. In doing this, the routing server 112 may query data that is relevant to the incoming interaction, for example, data relating to the particular customer, available agents, and the type of interaction, which, as described herein, may be stored in particular databases. Once the agent is selected, the routing server 112 may interact with the call controller 108 to route (i.e., connect) the incoming interaction to the corresponding agent device 118. As part of this connection, information about the customer may be provided to the selected agent via their agent device 118. This information is intended to enhance the service the agent is able to provide to the customer.

It should be appreciated that the contact center system 100 may include one or more mass storage devices—represented generally by the storage device 114—for storing data in one or more databases relevant to the functioning of the contact center. For example, the storage device 114 may store customer data that is maintained in a customer database. Such customer data may include, for example, customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 114 may store agent data in an agent database. Agent data maintained by the contact center system 100 may include, for example, agent availability and agent profiles, schedules, skills, handle time, and/or other relevant data. As another example, the storage device 114 may store interaction data in an interaction database. Interaction data may include, for example, data relating to numerous past interactions between customers and contact centers. More generally, it should be understood that, unless otherwise specified, the storage device 114 may be configured to include databases and/or store data related to any of the types of information described herein, with those databases and/or data being accessible to the other modules or servers of the contact center system 100 in ways that facilitate the functionality described herein. For example, the servers or modules of the contact center system 100 may query such databases to retrieve data stored therein or transmit data thereto for storage. The storage device 114, for example, may take the form of any conventional storage medium and may be locally housed or operated from a remote location. As an example, the databases may be Cassandra database, NoSQL database, or a SQL database and managed by a database management system, such as, Oracle, IBM DB2, Microsoft SQL server, or Microsoft Access, PostgreSQL.

The statistics server 116 may be configured to record and aggregate data relating to the performance and operational aspects of the contact center system 100. Such information may be compiled by the statistics server 116 and made available to other servers and modules, such as the reporting server 134, which then may use the data to produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 118 of the contact center system 100 may be communication devices configured to interact with the various components and modules of the contact center system 100 in ways that facilitate functionality described herein. An agent device 118, for example, may include a telephone adapted for regular telephone calls or VOIP calls. An agent device 118 may further include a computing device configured to communicate with the servers of the contact center system 100, perform data processing associated with operations, and interface with customers via voice, chat, email, and other multimedia communication mechanisms according to functionality described herein. Although FIG. 1 shows three such agent devices 118—i.e., agent devices 118A, 118B and 118C—it should be understood that any number of agent devices 118 may be present in a particular embodiment.

The multimedia/social media server 120 may be configured to facilitate media interactions (other than voice) with the customer devices 102 and/or the servers 128. Such media interactions may be related, for example, to email, voice mail, chat, video, text-messaging, web, social media, co-browsing, etc. The multimedia/social media server 120 may take the form of any IP router conventional in the art with specialized hardware and software for receiving, processing, and forwarding multi-media events and communications.

The knowledge management server 122 may be configured to facilitate interactions between customers and the knowledge system 124. In general, the knowledge system 124 may be a computer system capable of receiving questions or queries and providing answers in response. The knowledge system 124 may be included as part of the contact center system 100 or operated remotely by a third party. The knowledge system 124 may include an artificially intelligent computer system capable of answering questions posed in natural language by retrieving information from information sources such as encyclopedias, dictionaries, newswire articles, literary works, or other documents submitted to the knowledge system 124 as reference materials. As an example, the knowledge system 124 may be embodied as IBM Watson or a similar system.

The chat server 126, it may be configured to conduct, orchestrate, and manage electronic chat communications with customers. In general, the chat server 126 is configured to implement and maintain chat conversations and generate chat transcripts. Such chat communications may be conducted by the chat server 126 in such a way that a customer communicates with automated chatbots, human agents, or both. In exemplary embodiments, the chat server 126 may perform as a chat orchestration server that dispatches chat conversations among the chatbots and available human agents. In such cases, the processing logic of the chat server 126 may be rules driven so to leverage an intelligent workload distribution among available chat resources. The chat server 126 further may implement, manage, and facilitate user interfaces (UIs) associated with the chat feature, including those UIs generated at either the customer device 102 or the agent device 118. The chat server 126 may be configured to transfer chats within a single chat session with a particular customer between automated and human sources such that, for example, a chat session transfers from a chatbot to a human agent or from a human agent to a chatbot. The chat server 126 may also be coupled to the knowledge management server 122 and the knowledge systems 124 for receiving suggestions and answers to queries posed by customers during a chat so that, for example, links to relevant articles can be provided.

The web servers 128 may be included to provide site hosts for a variety of social interaction sites to which customers subscribe, such as Facebook, Twitter, Instagram, etc. Though depicted as part of the contact center system 100, it should be understood that the web servers 128 may be provided by third parties and/or maintained remotely. The web servers 128 may also provide webpages for the enterprise or organization being supported by the contact center system 100. For example, customers may browse the webpages and receive information about the products and services of a particular enterprise. Within such enterprise webpages, mechanisms may be provided for initiating an interaction with the contact center system 100, for example, via web chat, voice, or email. An example of such a mechanism is a widget, which can be deployed on the webpages or websites hosted on the web servers 128. As used herein, a widget refers to a user interface component that performs a particular function. In some implementations, a widget may include a graphical user interface control that can be overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Some widgets can include corresponding or additional user interfaces and be configured to access a variety of local resources (e.g., a calendar or contact information on the customer device) or remote resources via network (e.g., instant messaging, electronic mail, or social networking updates).

The interaction (iXn) server 130 may be configured to manage deferrable activities of the contact center and the routing thereof to human agents for completion. As used herein, deferrable activities may include back-office work that can be performed off-line, e.g., responding to emails, attending training, and other activities that do not entail real-time communication with a customer. As an example, the interaction (iXn) server 130 may be configured to interact with the routing server 112 for selecting an appropriate agent to handle each of the deferrable activities. Once assigned to a particular agent, the deferrable activity is pushed to that agent so that it appears on the agent device 118 of the selected agent. The deferrable activity may appear in a workbin as a task for the selected agent to complete. The functionality of the workbin may be implemented via any conventional data structure, such as, for example, a linked list, array, and/or other suitable data structure. Each of the agent devices 118 may include a workbin. As an example, a workbin may be maintained in the buffer memory of the corresponding agent device 118.

The universal contact server (UCS) 132 may be configured to retrieve information stored in the customer database and/or transmit information thereto for storage therein. For example, the UCS 132 may be utilized as part of the chat feature to facilitate maintaining a history on how chats with a particular customer were handled, which then may be used as a reference for how future chats should be handled. More generally, the UCS 132 may be configured to facilitate maintaining a history of customer preferences, such as preferred media channels and best times to contact. To do this, the UCS 132 may be configured to identify data pertinent to the interaction history for each customer such as, for example, data related to comments from agents, customer communication history, and the like. Each of these data types then may be stored in the customer database 222 or on other modules and retrieved as functionality described herein requires.

The reporting server 134 may be configured to generate reports from data compiled and aggregated by the statistics server 116 or other sources. Such reports may include near real-time reports or historical reports and concern the state of contact center resources and performance characteristics, such as, for example, average wait time, abandonment rate, and/or agent occupancy. The reports may be generated automatically or in response to specific requests from a requestor (e.g., agent, administrator, contact center application, etc.). The reports then may be used toward managing the contact center operations in accordance with functionality described herein.

The media services server 136 may be configured to provide audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), screen recording, speech recognition, dual tone multi frequency (DTMF) recognition, faxes, audio and video transcoding, secure real-time transport protocol (SRTP), audio conferencing, video conferencing, coaching (e.g., support for a coach to listen in on an interaction between a customer and an agent and for the coach to provide comments to the agent without the customer hearing the comments), call analysis, keyword spotting, and/or other relevant features.

The analytics module 138 may be configured to provide systems and methods for performing analytics on data received from a plurality of different data sources as functionality described herein may require. In accordance with example embodiments, the analytics module 138 also may generate, update, train, and modify predictors or models based on collected data, such as, for example, customer data, agent data, and interaction data. The models may include behavior models of customers or agents. The behavior models may be used to predict behaviors of, for example, customers or agents, in a variety of situations, thereby allowing embodiments of the present invention to tailor interactions based on such predictions or to allocate resources in preparation for predicted characteristics of future interactions, thereby improving overall contact center performance and the customer experience. It will be appreciated that, while the analytics module is described as being part of a contact center, such behavior models also may be implemented on customer systems (or, as also used herein, on the “customer-side” of the interaction) and used for the benefit of customers.

According to exemplary embodiments, the analytics module 138 may have access to the data stored in the storage device 114, including the customer database and agent database. The analytics module 138 also may have access to the interaction database, which stores data related to interactions and interaction content (e.g., transcripts of the interactions and events detected therein), interaction metadata (e.g., customer identifier, agent identifier, medium of interaction, length of interaction, interaction start and end time, department, tagged categories), and the application setting (e.g., the interaction path through the contact center). Further, the analytic module 138 may be configured to retrieve data stored within the storage device 114 for use in developing and training algorithms and models, for example, by applying machine learning techniques.

One or more of the included models may be configured to predict customer or agent behavior and/or aspects related to contact center operation and performance. Further, one or more of the models may be used in natural language processing and, for example, include intent recognition and the like. The models may be developed based upon known first principle equations describing a system; data, resulting in an empirical model; or a combination of known first principle equations and data. In developing a model for use with present embodiments, because first principles equations are often not available or easily derived, it may be generally preferred to build an empirical model based upon collected and stored data. To properly capture the relationship between the manipulated/disturbance variables and the controlled variables of complex systems, in some embodiments, it may be preferable that the models are nonlinear. This is because nonlinear models can represent curved rather than straight-line relationships between manipulated/disturbance variables and controlled variables, which are common to complex systems such as those discussed herein. Given the foregoing requirements, a machine learning or neural network-based approach may be a preferred embodiment for implementing the models. Neural networks, for example, may be developed based upon empirical data using advanced regression algorithms.

The analytics module 138 may further include an optimizer. As will be appreciated, an optimizer may be used to minimize a “cost function” subject to a set of constraints, where the cost function is a mathematical representation of desired objectives or system operation. Because the models may be non-linear, the optimizer may be a nonlinear programming optimizer. It is contemplated, however, that the technologies described herein may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like.

According to some embodiments, the models and the optimizer may together be used within an optimization system. For example, the analytics module 138 may utilize the optimization system as part of an optimization process by which aspects of contact center performance and operation are optimized or, at least, enhanced. This, for example, may include features related to the customer experience, agent experience, interaction routing, natural language processing, intent recognition, or other functionality related to automated processes.

The various components, modules, and/or servers of FIG. 1 (as well as the other figures included herein) may each include one or more processors executing computer program instructions and interacting with other system components for performing the various functionalities described herein. Such computer program instructions may be stored in a memory implemented using a standard memory device, such as, for example, a random-access memory (RAM), or stored in other non-transitory computer readable media such as, for example, a CD-ROM, flash drive, etc. Although the functionality of each of the servers is described as being provided by the particular server, a person of skill in the art should recognize that the functionality of various servers may be combined or integrated into a single server, or the functionality of a particular server may be distributed across one or more other servers without departing from the scope of the present invention. Further, the terms “interaction” and “communication” are used interchangeably, and generally refer to any real-time and non-real-time interaction that uses any communication channel including, without limitation, telephone calls (PSTN or VoIP calls), emails, vmails, video, chat, screen-sharing, text messages, social media messages, WebRTC calls, etc. Access to and control of the components of the contact center system 100 may be affected through user interfaces (UIs) which may be generated on the customer devices 102 and/or the agent devices 118.

As noted above, in some embodiments, the contact center system 100 may operate as a hybrid system in which some or all components are hosted remotely, such as in a cloud-based or cloud computing environment. It should be appreciated that each of the devices of the contact center system 100 may be embodied as, include, or form a portion of one or more computing devices similar to the computing device 200 described below in reference to FIG. 2.

Referring now to FIG. 2, a simplified block diagram of at least one embodiment of a computing device 200 is shown. The illustrative computing device 200 depicts at least one embodiment of each of the computing devices, systems, servicers, controllers, switches, gateways, engines, modules, and/or computing components described herein (e.g., which collectively may be referred to interchangeably as computing devices, servers, or modules for brevity of the description). For example, the various computing devices may be a process or thread running on one or more processors of one or more computing devices 200, which may be executing computer program instructions and interacting with other system modules in order to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described herein—such as the contact center system 100 of FIG. 1—the various servers and computer devices thereof may be located on local computing devices 200 (e.g., on-site at the same physical location as the agents of the contact center), remote computing devices 200 (e.g., off-site or in a cloud-based or cloud computing environment, for example, in a remote data center connected via a network), or some combination thereof. In some embodiments, functionality provided by servers located on computing devices off-site may be accessed and provided over a virtual private network (VPN), as if such servers were on-site, or the functionality may be provided using a software as a service (SaaS) accessed over the Internet using various protocols, such as by exchanging data via extensible markup language (XML), JSON, and/or the functionality may be otherwise accessed/leveraged.

In some embodiments, the computing device 200 may be embodied as a server, desktop computer, laptop computer, tablet computer, notebook, netbook, Ultrabook™, cellular phone, mobile computing device, smartphone, wearable computing device, personal digital assistant, Internet of Things (IoT) device, processing system, wireless access point, router, gateway, and/or any other computing, processing, and/or communication device capable of performing the functions described herein.

The computing device 200 includes a processing device 202 that executes algorithms and/or processes data in accordance with operating logic 208, an input/output device 204 that enables communication between the computing device 200 and one or more external devices 210, and memory 206 which stores, for example, data received from the external device 210 via the input/output device 204.

The input/output device 204 allows the computing device 200 to communicate with the external device 210. For example, the input/output device 204 may include a transceiver, a network adapter, a network card, an interface, one or more communication ports (e.g., a USB port, serial port, parallel port, an analog port, a digital port, VGA, DVI, HDMI, Fire Wire, CAT 5, or any other type of communication port or interface), and/or other communication circuitry. Communication circuitry of the computing device 200 may be configured to use any one or more communication technologies (e.g., wireless or wired communications) and associated protocols (e.g., Ethernet, Bluetooth®, Wi-Fi®, WiMAX, etc.) to effect such communication depending on the particular computing device 200. The input/output device 204 may include hardware, software, and/or firmware suitable for performing the techniques described herein.

The external device 210 may be any type of device that allows data to be inputted or outputted from the computing device 200. For example, in various embodiments, the external device 210 may be embodied as one or more of the devices/systems described herein, and/or a portion thereof. Further, in some embodiments, the external device 210 may be embodied as another computing device, switch, diagnostic tool, controller, printer, display, alarm, peripheral device (e.g., keyboard, mouse, touch screen display, etc.), and/or any other computing, processing, and/or communication device capable of performing the functions described herein. Furthermore, in some embodiments, it should be appreciated that the external device 210 may be integrated into the computing device 200.

The processing device 202 may be embodied as any type of processor(s) capable of performing the functions described herein. In particular, the processing device 202 may be embodied as one or more single or multi-core processors, microcontrollers, or other processor or processing/controlling circuits. For example, in some embodiments, the processing device 202 may include or be embodied as an arithmetic logic unit (ALU), central processing unit (CPU), digital signal processor (DSP), graphics processing unit (GPU), field-programmable gate array (FPGA), application-specific integrated circuit (ASIC), and/or another suitable processor(s). The processing device 202 may be a programmable type, a dedicated hardwired state machine, or a combination thereof. Processing devices 202 with multiple processing units may utilize distributed, pipelined, and/or parallel processing in various embodiments. Further, the processing device 202 may be dedicated to performance of just the operations described herein, or may be utilized in one or more additional applications. In the illustrative embodiment, the processing device 202 is programmable and executes algorithms and/or processes data in accordance with operating logic 208 as defined by programming instructions (such as software or firmware) stored in memory 206. Additionally or alternatively, the operating logic 208 for processing device 202 may be at least partially defined by hardwired logic or other hardware. Further, the processing device 202 may include one or more components of any type suitable to process the signals received from input/output device 204 or from other components or devices and to provide desired output signals. Such components may include digital circuitry, analog circuitry, or a combination thereof.

The memory 206 may be of one or more types of non-transitory computer-readable media, such as a solid-state memory, electromagnetic memory, optical memory, or a combination thereof. Furthermore, the memory 206 may be volatile and/or nonvolatile and, in some embodiments, some or all of the memory 206 may be of a portable type, such as a disk, tape, memory stick, cartridge, and/or other suitable portable memory. In operation, the memory 206 may store various data and software used during operation of the computing device 200 such as operating systems, applications, programs, libraries, and drivers. It should be appreciated that the memory 206 may store data that is manipulated by the operating logic 208 of processing device 202, such as, for example, data representative of signals received from and/or sent to the input/output device 204 in addition to or in lieu of storing programming instructions defining operating logic 208. As shown in FIG. 2, the memory 206 may be included with the processing device 202 and/or coupled to the processing device 202 depending on the particular embodiment. For example, in some embodiments, the processing device 202, the memory 206, and/or other components of the computing device 200 may form a portion of a system-on-a-chip (SoC) and be incorporated on a single integrated circuit chip.

In some embodiments, various components of the computing device 200 (e.g., the processing device 202 and the memory 206) may be communicatively coupled via an input/output subsystem, which may be embodied as circuitry and/or components to facilitate input/output operations with the processing device 202, the memory 206, and other components of the computing device 200. For example, the input/output subsystem may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The computing device 200 may include other or additional components, such as those commonly found in a typical computing device (e.g., various input/output devices and/or other components), in other embodiments. It should be further appreciated that one or more of the components of the computing device 200 described herein may be distributed across multiple computing devices. In other words, the techniques described herein may be employed by a computing system that includes one or more computing devices. Additionally, although only a single processing device 202, I/O device 204, and memory 206 are illustratively shown in FIG. 2, it should be appreciated that a particular computing device 200 may include multiple processing devices 202, I/O devices 204, and/or memories 206 in other embodiments. Further, in some embodiments, more than one external device 210 may be in communication with the computing device 200.

The computing device 200 may be one of a plurality of devices connected by a network or connected to other systems/resources via a network. The network may be embodied as any one or more types of communication networks that are capable of facilitating communication between the various devices communicatively connected via the network. As such, the network may include one or more networks, routers, switches, access points, hubs, computers, client devices, endpoints, nodes, and/or other intervening network devices. For example, the network may be embodied as or otherwise include one or more cellular networks, telephone networks, local or wide area networks, publicly available global networks (e.g., the Internet), ad hoc networks, short-range communication links, or a combination thereof. In some embodiments, the network may include a circuit-switched voice or data network, a packet-switched voice or data network, and/or any other network able to carry voice and/or data. In particular, in some embodiments, the network may include Internet Protocol (IP)-based and/or asynchronous transfer mode (ATM)-based networks. In some embodiments, the network may handle voice traffic (e.g., via a Voice over IP (VOIP) network), web traffic, and/or other network traffic depending on the particular embodiment and/or devices of the system in communication with one another. In various embodiments, the network may include analog or digital wired and wireless networks (e.g., IEEE 802.11 networks, Public Switched Telephone Network (PSTN), Integrated Services Digital Network (ISDN), and Digital Subscriber Line (xDSL)), Third Generation (3G) mobile telecommunications networks, Fourth Generation (4G) mobile telecommunications networks, Fifth Generation (5G) mobile telecommunications networks, a wired Ethernet network, a private network (e.g., such as an intranet), radio, television, cable, satellite, and/or any other delivery or tunneling mechanism for carrying data, or any appropriate combination of such networks. It should be appreciated that the various devices/systems may communicate with one another via different networks depending on the source and/or destination devices/systems.

It should be appreciated that the computing device 200 may communicate with other computing devices 200 via any type of gateway or tunneling protocol such as secure socket layer or transport layer security. The network interface may include a built-in network adapter, such as a network interface card, suitable for interfacing the computing device to any type of network capable of performing the operations described herein. Further, the network environment may be a virtual network environment where the various network components are virtualized. For example, the various machines may be virtual machines implemented as a software-based computer running on a physical machine. The virtual machines may share the same operating system, or, in other embodiments, different operating system may be run on each virtual machine instance. For example, a “hypervisor” type of virtualizing is used where multiple virtual machines run on the same host physical machine, each acting as if it has its own dedicated box. Other types of virtualization may be employed in other embodiments, such as, for example, the network (e.g., via software defined networking) or functions (e.g., via network functions virtualization).

Accordingly, one or more of the computing devices 200 described herein may be embodied as, or form a portion of, one or more cloud-based systems. In cloud-based embodiments, the cloud-based system may be embodied as a server-ambiguous computing solution, for example, that executes a plurality of instructions on-demand, contains logic to execute instructions only when prompted by a particular activity/trigger, and does not consume computing resources when not in use. That is, system may be embodied as a virtual computing environment residing “on” a computing system (e.g., a distributed network of devices) in which various virtual functions (e.g., Lambda functions, Azure functions, Google cloud functions, and/or other suitable virtual functions) may be executed corresponding with the functions of the system described herein. For example, when an event occurs (e.g., data is transferred to the system for handling), the virtual computing environment may be communicated with (e.g., via a request to an API of the virtual computing environment), whereby the API may route the request to the correct virtual function (e.g., a particular server-ambiguous computing resource) based on a set of rules. As such, when a request for the transmission of data is made by a user (e.g., via an appropriate user interface to the system), the appropriate virtual function(s) may be executed to perform the actions before eliminating the instance of the virtual function(s).

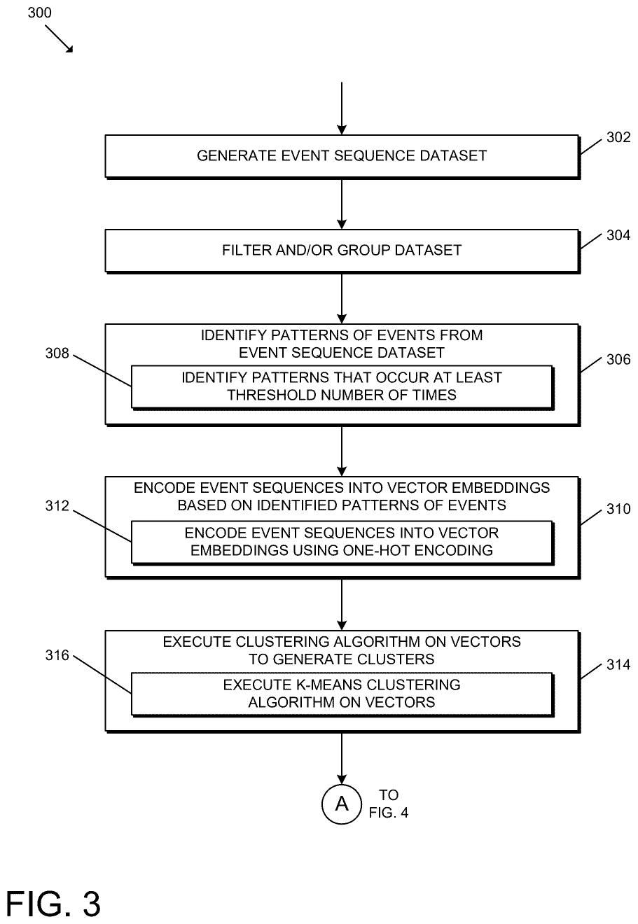

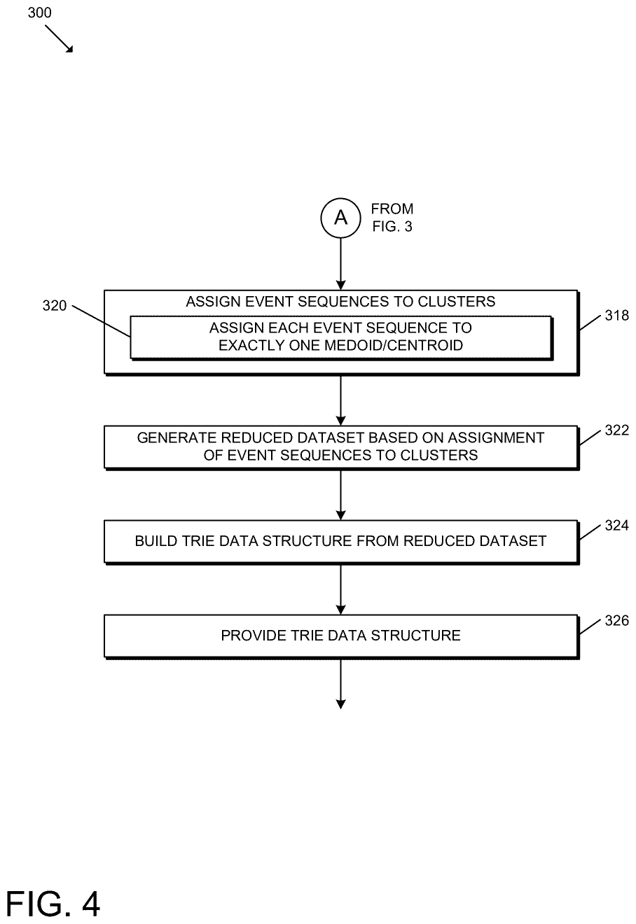

Referring now to FIGS. 3-4, a computing system (e.g., the contact center system 100, one or more computing devices 200, and/or other computing devices described herein) may execute a method 300 of using pattern mining to reduce noise for event sequence visualization. It should be appreciated that the particular blocks of the method 300 are illustrated by way of example, and such blocks may be combined or divided, added or removed, and/or reordered in whole or in part depending on the particular embodiment, unless stated to the contrary.

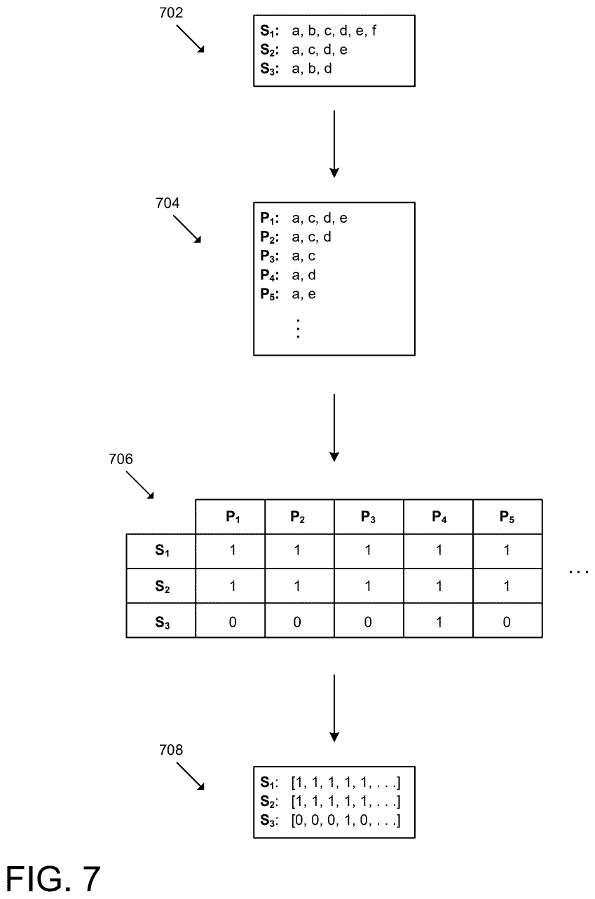

The illustrative method 300 begins with block 302 of FIG. 3 in which the computing system generates or otherwise determines an event sequence dataset. In particular, the computing system may determine each of the event sequences involved (or possible) for a particular system implementation. As described herein, in various embodiments, each of the event sequences may be a web-based journey experienced by (or possible to be experienced by) a user, a contact center bot flow or other bot flow experienced by (or possible to be experienced by) a user interacting with the bot (e.g., of a contact center system), a response sequence of an interactive voice response (IVR) system (e.g., of a contact center system), and/or another type of event sequence. For example, as depicted by the event sequence dataset 702 of FIG. 7, the event sequences include S₁=(a, b, c, d, e, f), S₂=(a, c, d, c), and S₃=(a, b, d). It should be appreciated that the event sequence dataset includes data for a plurality of event sequences, and each event sequence includes at least one event. In other embodiments, it should be appreciated that each event sequence must include at least two events.

In block 304, the computing system may filter and/or group the event sequence dataset by each unique sequence/flow identifier, exit category, and/or other relevant criteria. For example, in some embodiments, the computing system may filter the event sequence dataset according to one or more of the method described in U.S. application Ser. No. 18/505,900, titled “Technologies for Filtering and Querying Trie Data Structures for Generating Real-Time Bot Flow Visualizations and Analytics” and filed on Nov. 9, 2023, the entirety of which is incorporated herein by reference.

In block 306, the computing system mines or otherwise identifies patterns of events from the event sequence dataset. More specifically, in block 308, the computing system may identify patterns of events from the event sequence dataset that occur at least a threshold number of times. For example, in some embodiments, the computing system identifies patterns of events that occur at least twice in the event sequence dataset. In other words, the computing system may determine how many times a pattern occurs in each of the event sequences within the event sequence dataset. In some embodiments, the computing system may execute a heuristic to determine the threshold number of times. Further, in some embodiments, the computing system may execute a sequence-to-pattern (Seq2Pat) generation algorithm to perform pattern mining on the event sequence dataset using machine learning to identify the event patterns. In other embodiments, however, it should be appreciated that the computing system may execute one or more other pattern mining algorithms. For example, in various embodiments, the computing system may leverage various algorithms and/or techniques including one or more of sequential pattern mining (SPM), dichotomic pattern mining (DPM), spanning-tree progression analysis of density-normalized events (SPADE), PrefixSpan, generalized sequential pattern (GSP), Apriori, and/or other pattern mining algorithms/techniques. As shown in the example of FIG. 7, the event patterns 704 mined/identified from the event sequence dataset 702 include the event patterns, P₁=(a, c, d, c), P₂=(a, c, d), P₃=(a, c), P₄=(a, d), and P₅=(a, c). It should be appreciated that each of the event patterns P₁, P₂, P₃, P₄, and P₅ occurs in at least two of the event sequences S₁, S₂, and S₃. It should be further appreciated that the list of event patterns 704 of FIG. 7 is merely a partial list for illustrative purposes (e.g., as indicated by the ellipsis).

In block 310, the computing system encodes each event sequence into a vector embedding based on the identified patterns of events, thereby generating corresponding vectors. In particular, in block 312, the computing system may encode each event sequence into a vector embedding using one-hot encoding, such that each pattern is a dimension in the vector space. For example, as shown in the example of FIG. 7, each of the event sequences S₁, S₂, and S₃ may be vectorized by determining whether it includes each pattern P₁, P₂, P₃, P₄, and P₅. The matrix 706 is provided for illustrative purposes. The matrix 706 lists each event sequence from the event sequence dataset 702 against each event pattern 704. The matrix 706 includes the value of “1” if a particular pattern is included in the respective event sequence or the value of “0” if the particular pattern is not included in the respective event sequence. As shown, the vectors 708 generated for the event sequences are S₁: [1, 1, 1, 1, 1, . . . ], S₂: [1, 1, 1, 1, 1, . . . ], and S₃: [0, 0, 0, 1, 0, . . . ]. It should be appreciated that the ellipses in the vectors 408 reflect that a full set of event patterns was not illustrated in FIG. 7. It should be further appreciated that the vectors 708 may efficiently and succinctly inform a machine learning algorithm which patterns exist in each event sequence. Further, in other embodiments, the values/characters used to represent the presence/absence of a particular pattern may be different from those described above.

In block 314, the computing system executes a clustering algorithm on the vectors to generate clusters. In other words, the vectors are provided as inputs to a machine learning clustering algorithm trained to group similar elements together. In particular, in block 316, the computing system may execute a k-means clustering algorithm on the vectors to generate the clusters. It should be appreciated that, in other embodiments, the computing system may execute one or more other clustering algorithms. For example, in various embodiments, the computing system may leverage various algorithms and/or techniques including one or more of clustering for large applications (CLARA), clustering large applications based upon randomized search (CLARANS), and/or other clustering algorithms/techniques. It should be appreciated that each of the clusters output by the clustering algorithm may be identified or associated with a centroid or medoid.

In block 318 of FIG. 4, the computing system assigned each event sequence to one of the clusters based on the cluster allocations. In particular, in block 320, the computing system assigns each event sequence to exactly one (i.e., one and only one) centroid or medoid of the respective cluster or, more generally, assigns each event sequence to exactly one cluster. In other words, each of the event sequences is assigned to the nearest cluster or, more specifically, the nearest centroid/medoid. In block 322, the computing system generates a reduced dataset based on the assignment of the event sequences to the clusters. For example, in the illustrative embodiment, the event sequence dataset is reduced to the set of clusters or, more specifically, the set of centroids/medoids, and the assignment of each event sequence to its respective cluster may deterministically contribute to flow counts for each centroid/medoid. In other words, the reduced dataset defined by the centroids/medoids may function as representative event sequences/journeys for visualization as described herein. Accordingly, in block 324, the computing system builds a data structure (e.g., a Trie data structure) for event sequence visualization based on the reduced dataset. In block 326, the computing system provides the data structure (e.g., the Trie data structure) to a user (e.g., an administrative user). For example, in some embodiments, a graphical representation of the data structure may be displayed on a graphical user interface for event sequence visualization.

Although the blocks 302-326 are described in a relatively serial manner, it should be appreciated that various blocks of the method 300 may be performed in parallel in some embodiments.

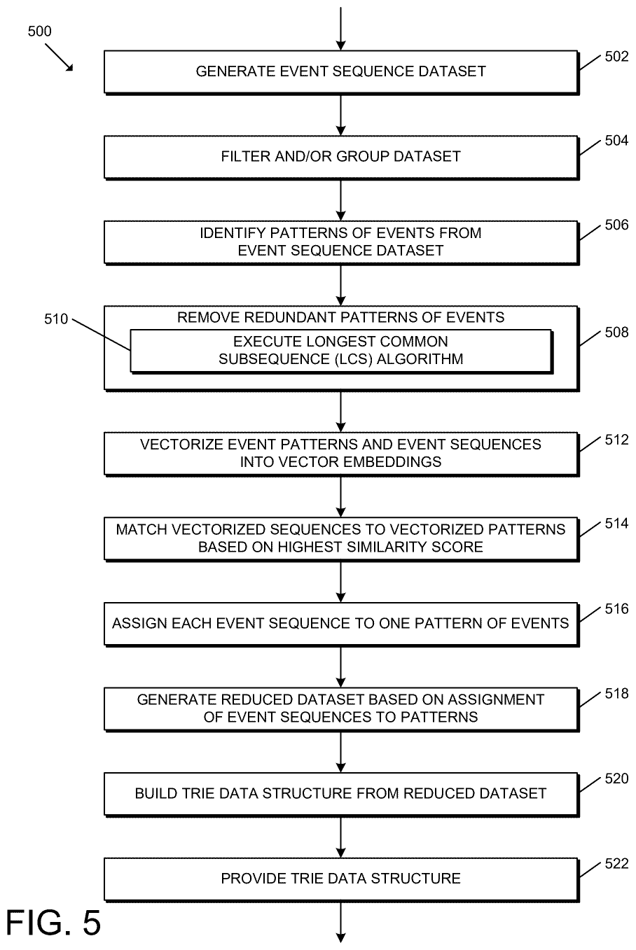

Referring now to FIG. 5, a computing system (e.g., the contact center system 100, one or more computing devices 200, and/or other computing devices described herein) may execute a method 500 of using pattern mining to reduce noise for event sequence visualization. It should be appreciated that the particular blocks of the method 500 are illustrated by way of example, and such blocks may be combined or divided, added or removed, and/or reordered in whole or in part depending on the particular embodiment, unless stated to the contrary.

The illustrative method 500 begins with block 502 in which the computing system generates or otherwise determines an event sequence dataset. In particular, as described above, the computing system may determine each of the event sequences involved (or possible) for a particular system implementation. In various embodiments, each of the event sequences may be a web-based journey experienced by (or possible to be experienced by) a user, a contact center bot flow or other bot flow experienced by (or possible to be experienced by) a user interacting with the bot (e.g., of a contact center system), a response sequence of an interactive voice response (IVR) system (e.g., of a contact center system), and/or another type of event sequence.

In block 504, the computing system may filter and/or group the event sequence dataset by each unique sequence/flow identifier, exit category, and/or other relevant criteria. For example, in some embodiments, the computing system may filter the event sequence dataset according to one or more of the method described in U.S. application Ser. No. 18/505,900, titled “Technologies for Filtering and Querying Trie Data Structures for Generating Real-Time Bot Flow Visualizations and Analytics” and filed on Nov. 9, 2023, the entirety of which is incorporated herein by reference.

In block 506, the computing system mines or otherwise identifies patterns of events from the event sequence dataset. In doing so, in some embodiments, the computing system may execute a sequence-to-pattern (Seq2Pat) generation algorithm to perform pattern mining on the event sequence dataset using machine learning to identify the event patterns. In other embodiments, however, it should be appreciated that the computing system may execute one or more other pattern mining algorithms. For example, in various embodiments, the computing system may leverage various algorithms and/or techniques including one or more of sequential pattern mining (SPM), dichotomic pattern mining (DPM), spanning-tree progression analysis of density-normalized events (SPADE), PrefixSpan, generalized sequential pattern (GSP), Apriori, and/or other pattern mining algorithms/techniques.

In block 508, the computing system removes redundant patterns of events from the set of identified event patterns. In doing so, in block 510, the computing system may execute the longest common subsequence (LCS) algorithm to remove any redundant patterns that have a super-sequence in the set. It should be appreciated that the computing system may execute another suitable algorithm for removing redundant patterns in other embodiments.

In block 512, the computing system vectorizes the event patterns and event sequences into vector embeddings for analysis, and in block 514, the computing system matches vectorized sequences to vectorized patterns based on the highest similarity score. In block 516, the computing system assigns each event sequence to exactly one (i.e., one and only one) event pattern, which may deterministically contribute to flow counts for each event pattern.

In block 518, the computing system generates a reduced dataset based on the assignment of the event sequences to the event patterns, where each pattern has a per-flow count associated with it. In block 520, the computing system builds a data structure (e.g., a Trie data structure) for event sequence visualization based on the reduced dataset. In block 522, the computing system provides the data structure (e.g., the Trie data structure) to a user (e.g., an administrative user). For example, in some embodiments, a graphical representation of the data structure may be displayed on a graphical user interface for event sequence visualization.

Although the blocks 502-522 are described in a relatively serial manner, it should be appreciated that various blocks of the method 500 may be performed in parallel in some embodiments.

What is claimed is:

1. A method of reducing noise for event sequence visualization, the method comprising:
identifying, by a computing system, patterns of events from an event sequence dataset, wherein the event sequence dataset includes data for a plurality of event sequences, and wherein each event sequence of the plurality of events sequences includes at least one event;
encoding, by the computing system, each event sequence of the plurality of event sequences into a respective vector embedding based on the identified patterns of events to generate a plurality of vectors;
executing, by the computing system, a clustering algorithm on the plurality of vectors to generate a plurality of clusters;
assigning, by the computing system, each event sequence of the plurality of event sequences to a respective cluster of the plurality of clusters;
generating, by the computing system, a reduced dataset based on the assignment of the plurality of event sequences to the plurality of clusters; and
building, by the computing system, a data structure for event sequence visualization based on the reduced dataset.

2. The method of claim 1, wherein building the data structure for event sequence visualization based on the reduced dataset comprises building a Trie data structure for event sequence visualization based on the reduced dataset.

3. The method of claim 1, wherein identifying the patterns of events from the event sequence dataset comprises identifying patterns of events that occur at least a threshold number of times in the event sequence dataset.

4. The method of claim 1, wherein identifying the patterns of events from the event sequence dataset comprises identifying patterns of events that occur at least twice in the event sequence dataset.

5. The method of claim 1, wherein encoding each event sequence of the plurality of event sequences into the respective vector embedding comprises encoding each event sequence of the plurality of event sequences into a respective vector embedding using one-hot encoding.

6. The method of claim 1, wherein executing the clustering algorithm on the plurality of vectors to generate the plurality of clusters comprises executing a k-means clustering algorithm on the plurality of vectors to generate the plurality of clusters.

7. The method of claim 1, wherein assigning each event sequence of the plurality of event sequences to the respective cluster of the plurality of clusters comprises assigning each event sequence of the plurality of event sequences to one and only one respective cluster of the plurality of clusters.

8. The method of claim 1, wherein assigning each event sequence of the plurality of event sequences to the respective cluster of the plurality of clusters comprises assigning each event sequence of the plurality of event sequences to a medoid or centroid determined by the clustering algorithm.

9. The method of claim 1, wherein each event sequence of the plurality of event sequences comprises a contact center bot flow of an organization.

10. The method of claim 1, wherein the event sequence dataset comprises data associated with events of an interactive voice response (IVR) system of a contact center system.

11. The method of claim 1, further comprising displaying, by the computing system, a graphical representation of the data structure for event sequence visualization in response to building the data structure.

12. A system of reducing noise for event sequence visualization, the system comprising:
at least one processor; and
at least one memory comprising a plurality of instructions stored thereon that, in response to execution by the at least one processor, causes the system to:
identify patterns of events from an event sequence dataset, wherein the event sequence dataset includes data for a plurality of event sequences, and wherein each event sequence of the plurality of events sequences includes at least one event;
encode each event sequence of the plurality of event sequences into a respective vector embedding based on the identified patterns of events to generate a plurality of vectors;
execute a clustering algorithm on the plurality of vectors to generate a plurality of clusters;
assign each event sequence of the plurality of event sequences to a respective cluster of the plurality of clusters;
generate a reduced dataset based on the assignment of the plurality of event sequences to the plurality of clusters; and
build a data structure for event sequence visualization based on the reduced dataset.

13. The system of claim 12, wherein to build the data structure for event sequence visualization based on the reduced dataset comprises to build a Trie data structure for event sequence visualization based on the reduced dataset.

14. The system of claim 12, wherein to identify the patterns of events from the event sequence dataset comprises to identify patterns of events that occur at least twice in the event sequence dataset.

15. The system of claim 12, wherein to encode each event sequence of the plurality of event sequences into the respective vector embedding comprises to encode each event sequence of the plurality of event sequences into a respective vector embedding using one-hot encoding.

16. The system of claim 12, wherein to execute the clustering algorithm on the plurality of vectors to generate the plurality of clusters comprises to execute a k-means clustering algorithm on the plurality of vectors to generate the plurality of clusters.

17. The system of claim 12, wherein to assign each event sequence of the plurality of event sequences to the respective cluster of the plurality of clusters comprises to assign each event sequence of the plurality of event sequences to one and only one respective cluster of the plurality of clusters.

18. The system of claim 12, wherein to assign each event sequence of the plurality of event sequences to the respective cluster of the plurality of clusters comprises to assign each event sequence of the plurality of event sequences to a medoid or centroid determined by the clustering algorithm.

19. The system of claim 12, wherein each event sequence of the plurality of event sequences comprises a contact center bot flow of an organization.

20. The system of claim 12, wherein the event sequence dataset comprises data associated with events of an interactive voice response (IVR) system of a contact center system.
